(19) United States
(12) Patent Application Publication
(10) Pub. No.: US 2004/0265511 A1
(43) Pub. Date: Dec. 30, 2004

(54) Sculpting kit

(76) Inventors: Richard Miller, San Rafael, CA (US); Erik Jensen, Sonoma, CA (US)

Correspondence Address: Paul K. Tomita, Dergosits & Noah LLP, Suite 1450, Four Embarcadero Center, San Francisco, CA, 94111, US

(21) Appl. No.: 10/836,471

(22) Filed: Apr. 29, 2004

Related U.S. Application Data
(60) Provisional application No. 60/467,001, filed on Apr. 30, 2003.

(51) Int. Cl. A01N 1/00

(52) U.S. Cl. 428/16

(57) ABSTRACT

A sculpture kit includes a three-dimensional armature which has a head, eye indentations, an upper jaw and a lower jaw that is connected to the upper jaw with a hinge. Modeling clay, appendages, eyeballs and other details are attached to the armature to create the sculpture. The clay may be baked to harden and thereafter paint is applied to create a sculptured head. A fitting is connected to the bottom of the armature to assist with mounting the finished sculpture to a base or connector.

This patent application claims priority to U.S. Provisional Patent Application Ser. No. 60/467,001 filed Apr. 31, 2003.

### BACKGROUND

People have been sculpting figurines and heads using modeling clay for many years. These sculptures have been formed from solid clay by hand and with tools used to form detailed features. The sculptures are solid clay and the shape of these sculptures becomes permanent when the clay dries and hardens or is baked. A problem with many clay sculptures is that the clay alone does not have inherent structural strength to support the shape.

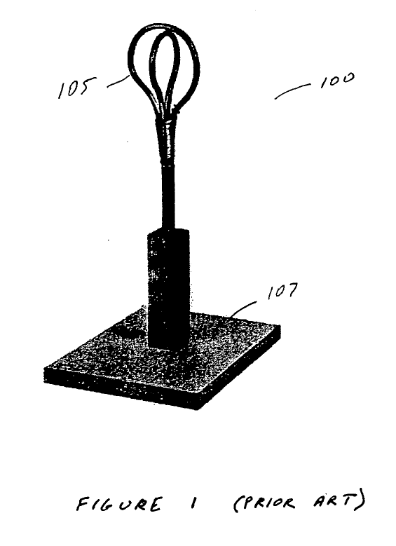

Wire armatures have been developed which aid artists in sculpting figurines and heads. The wire armatures are bendable and can be formed into rough shapes. For example with reference to FIG. 1, a head armature 100 may be a couple of wires 105 bent into a circular or bulb shape. The wire armatures allow the clay to be attached to a structure. The armature is also attached to a base 107 so the final sculpture can be displayed easily. The clay is applied to the wire armature such that the wires provide some support for the clay sculpture.

Modeling clay has also been applied to skulls or models of skulls to form heads and predict the appearance of historic or prehistoric animals and human beings. The use of skulls provides a surface upon which the rough shape of an animal or human head and face can be formed. Although a head can be formed by applying clay to the skull, many surface features of the head are formed around non-bony material such as cartilage and muscle. For example, the nose of a skull is a hole an it is difficult to determine the appearance of the person's nose based upon the skull. These head features cannot always be determined just from the skull itself.

What is needed is a mass produced structure having basic underlying facial features upon which clay can be applied to simplify the process and supply overt direction to the sculptor in the creation of realistic or imaginary human, animal, or non realistic fantasy creature heads and bodies.

### SUMMARY OF THE INVENTION

The invention is a sculpture kit which is more efficient and allows less experienced artists to produce more realistic sculptures. The primary component of the sculpture kit is a plastic armature that is in the basic shape of a head. The armature may have the basic facial and head features. For example a human head armature may include a normal cranium shape, eye sockets, teeth, nose, cheeks, jaw and chin. These facial features provide surfaces upon which a layer of clay is attached. Various other items may be placed onto the armature after the clay has been attached. In particular artificial eyeballs which include pupils and other details are inserted into the eye sockets. Also the teeth and jaw of the inventive armature are highly detailed and allow the sculpture to have exposed teeth and an open mouth that result in a life like creation that is positioned by the artist. After the clay has dried, the sculpture may be painted to give the sculpture a realistic appearance

Because the armature has the basic shape of the finished sculpture, the process for creating the finished sculpture is greatly simplified. Rather than forming the entire shape of the sculpture by hand, the artist only needs to apply a layer of clay to the armature to get an accurate basic head shape. Another benefit of the armature is that it allows multiple sculptures of a consistent size to be made. For example, if the same size armature is used for several sculptures, it is possible to make each appear to be distinct, yet have approximately the same size. In contrast, it is much more difficult to create a group of sculptures that are the same size with a wire armature or from clay alone.

Although the human head armature may resemble a human skull, there may be some significant differences. The eye sockets of the armature may be larger than a skull. This is so that a layer of clay can be inserted between the eyeballs and the eye sockets. In contrast a normal skull eye socket closely matches the eyeball size. Another difference is the nose. The armature has a protrusion while the skull has a hole.

### DETAILED DESCRIPTION OF THE DRAWINGS

The present invention is illustrated by way of example and not limitation in the figures of the accompanying drawings, in which like references indicate similar elements, and in which:

FIG. 1 illustrates an example of a prior art wire armature;

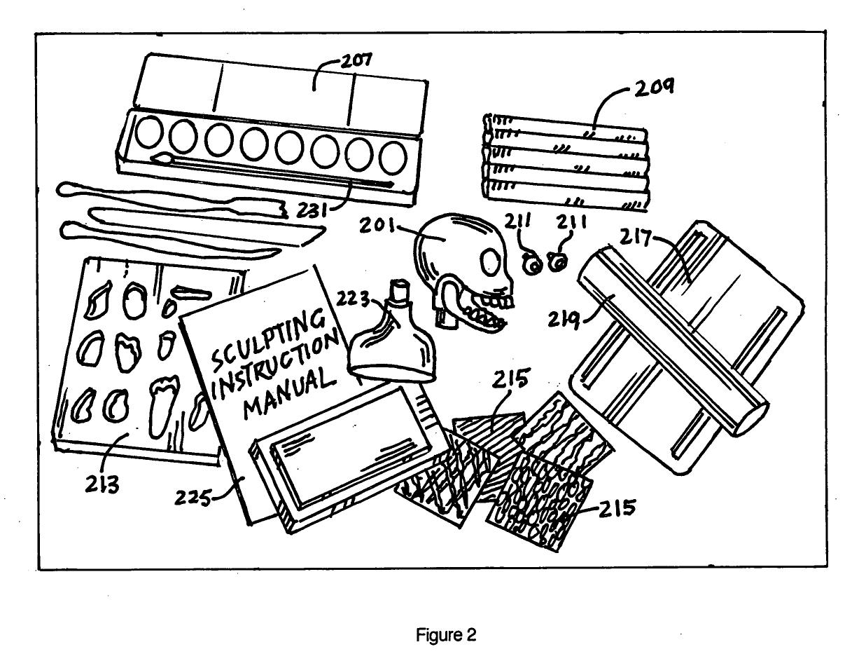

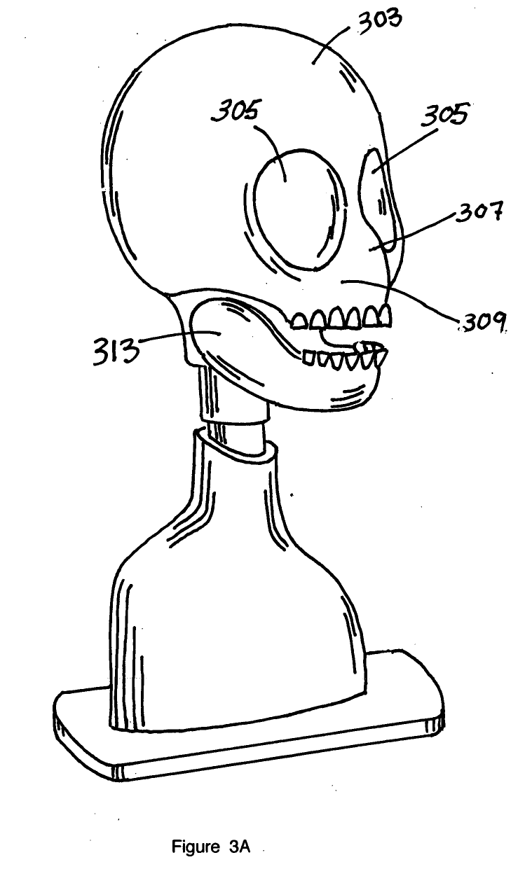

FIG. 2 illustrates the components of the modeling kit;

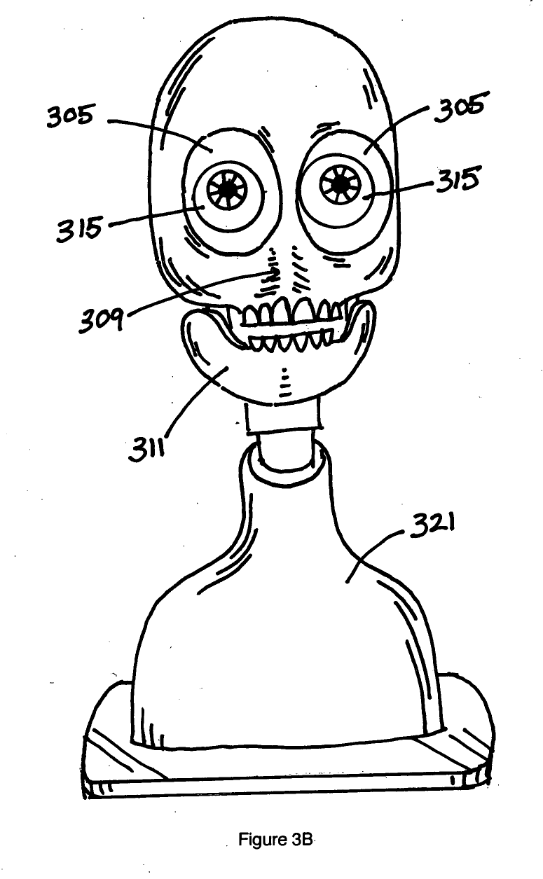

FIG. 3A illustrates a human head embodiment of the inventive armature;

FIG. 3B illustrates a human head embodiment of the inventive armature with eyeballs inserted;

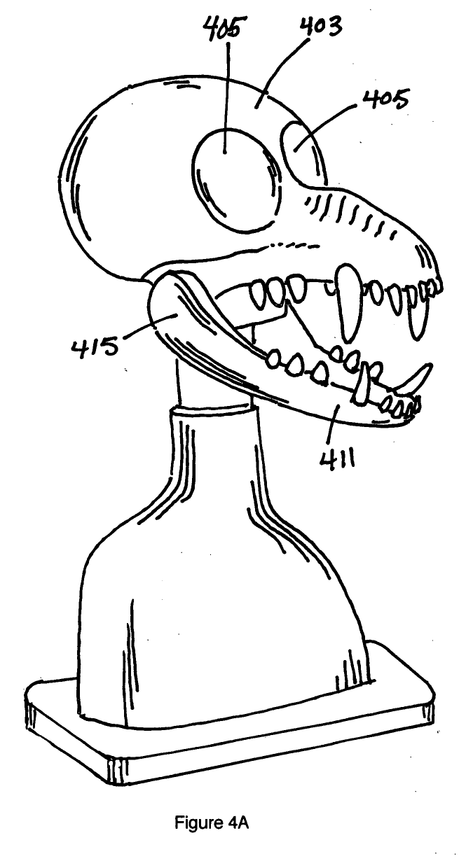

FIG. 4A illustrates a creature head embodiment of the inventive armature;

FIG. 4B illustrates a creature head embodiment of the inventive armature with eyeballs inserted;

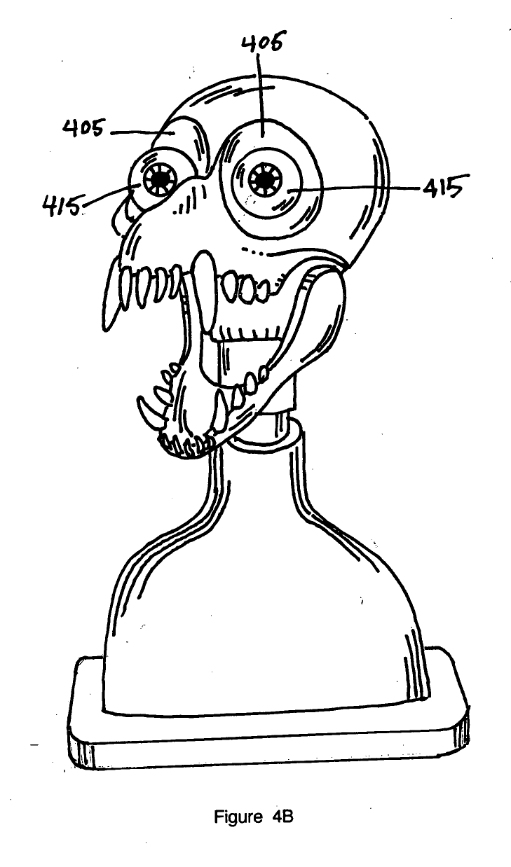

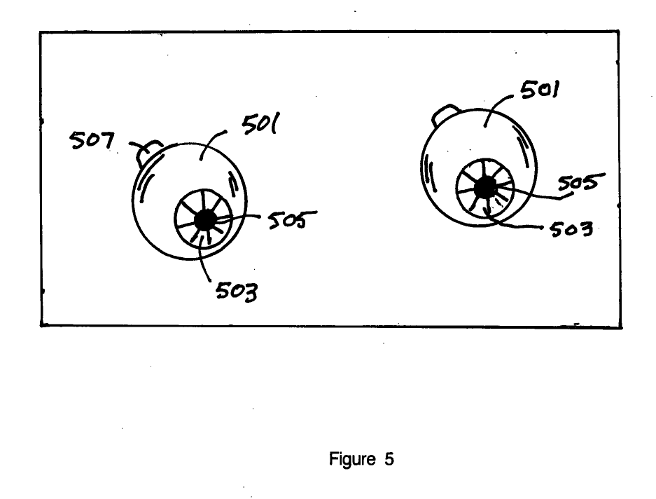

FIG. 5 illustrates plastic eyeballs;

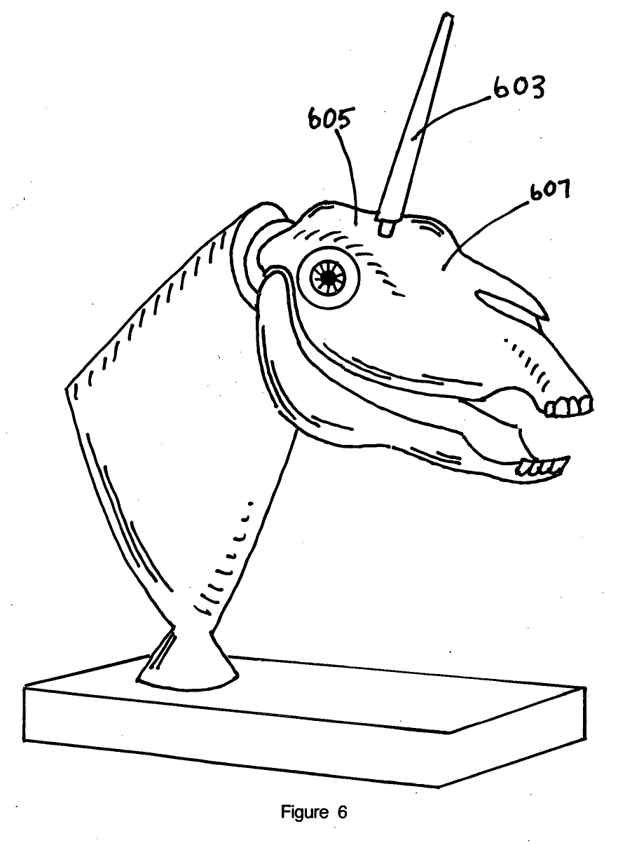

FIG. 6 illustrates a unicorn head armature;

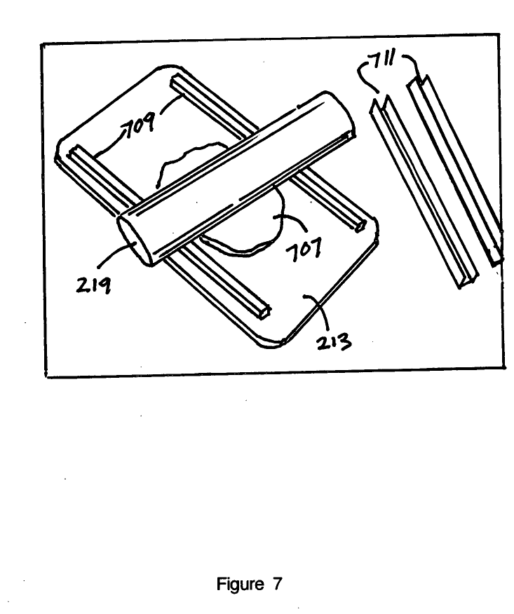

FIG. 7 illustrates a clay roller system; and

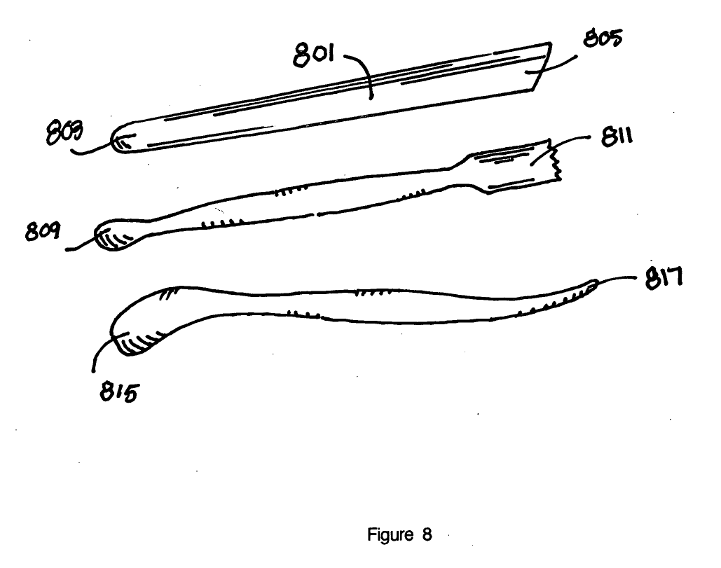

FIG. 8 illustrates sculpture tools used with the kit; and

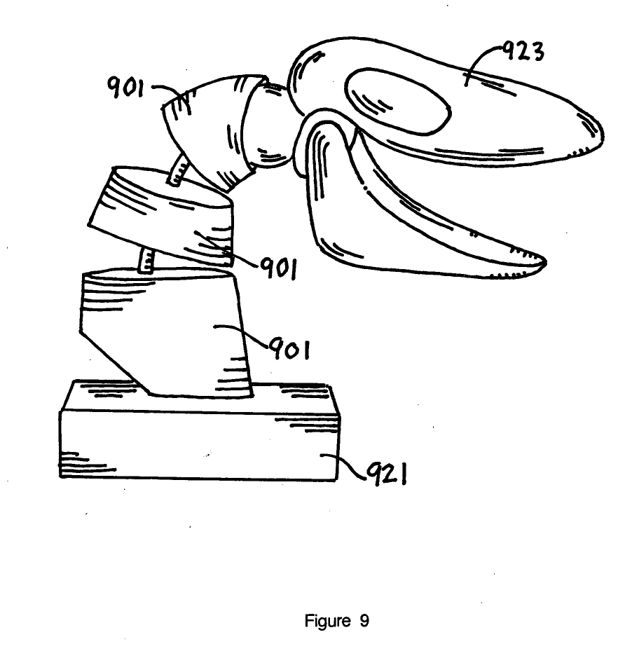

FIG. 9 illustrates an articulating neck for the armature.

### DETAILED DESCRIPTION

The inventive sculpting kit allows users to more easily and successfully produce realistic sculptures that represent real or imaginary beings and may include various components which assist the artist in creating a sculpture. With reference to FIG. 2, the sculpture kit components may include: an armature 201, a base for display 203, sculpting tools 205, paint 207, modeling clay 209, eyeballs 211, molds to create details 213, textured sheets 215, a board 217, a roller 219, a brush 221, a base 223, instructional materials 225 and sculpting tools and other accessories. The instructional materials 225 which may be illustrations and instructions written on paper that include all the information needed to teach an individual how to form a finished sculpture from the kit components. Alternatively or in addition to the paper instructions, video instructions may also be provided. The video may be in the form of a digital video disk or any other type of tape or electronic memory. The video may have footage of people using the kits components to make finished sculptures as well as visual and audible instructions.

The sculptures are formed by applying modeling clay 209 to the armature 201 and inserting the eyes 211 into the eye sockets to form a head. The armature 201 is a three-dimensional structure which can resemble a human head, an animal head or the head of any other type of creature. The armature 201 has the basic facial features.

With reference to FIG. 3A, an armature is illustrated that has the proportions of a human head. The armature includes a cranium 303, eye sockets 305, nose protrusion 307, an upper jaw with teeth 309 and a movable lower jaw with teeth 311. The lower jaw 311 may be attached to the upper jaw 309 with pins 313 or hinges that allow the lower jaw 311 to move. This lower jaw 311 movement allows the mouth of the sculpture to be positioned anywhere between fully opened and closed. The teeth are white to simulate actual animal teeth.

Note that the armature is different than a scaled down human skull. The nose is a protrusion rather than a hole and the eye sockets are proportionally larger than a human skull. With reference to FIG. 3B, these larger eye sockets 305 accommodate clay and correctly scaled plastic eyeballs 315. The armatures of animals are similarly distinct from the corresponding animal skull.

Another important feature of the inventive armature is a built in fitting which allows the finished sculpture to be easily attached to a base or other holder. This mechanism simplifies the fabrication process because it allows the clay to be attached to armature without the base, but allows the base to be attached when the sculpture is complete. The clay of the completed sculpture can then hardened without touching any other surfaces. Without this fitting, a special attachment would have to be made to hold the sculpture upright. Alternatively with reference to FIG. 1, some prior art armatures do not allow the base to be removed which can be inconvenient during the sculpting process.

The proportions of the armature will vary depending upon the type of animal being sculpted. For example, if the armature is for a dog head, the armature may have a longer nose and a different jaw and teeth but may also include the basic facial features of: eye sockets, a movable jaw and teeth. Thus by varying the dimensions, armatures can be made for all types of animals. The inventive armature is not limited to real creatures only but may have, for example, only one eye socket, four eye sockets or any number of eye sockets for that matter. The teeth may be farcical or savagely long and sharp. The cranium may be bulbous, enlarged or pointy.

This head armature provides the artist with a solid beginning form. With this basic form, the sculptor can focus on the more detailed characteristics of the sculpture. Working within those characteristics, the sculptor can come up with various features to suit his or her discretion. Another advantage of the inventive armature is that a character can be developed and by using the same armature, multiple sculptures of the same character can be more easily produced with each sculpture having its own expression. The inventive armature also simplifies the production of multiple characters which each must be the same size.

With reference to FIG. 4A, an armature is illustrated that has the proportions of a toothed head, such as a dinosaur. Like the human head armature, the armature includes a cranium 403, eye sockets 405, an extended nose that is integrated into the upper jaw with teeth 409 and a movable lower jaw with teeth 411. Again, the lower jaw 411 is attached the armature with a hinge or pins 413. With reference to FIG. 4B, the eye sockets 405 are larger than a creature skull to accommodate clay and correctly sized plastic eyeballs 415.

Although only two specific armatures have been illustrated, it is contemplated that this inventive armature will include various other types of animal heads, realistic or fictitious in appearance.

In yet another embodiment, the armature itself is modular with interchangeable nose protrusions, jaws, teeth and eye sockets. In this embodiment, the sculptor can select various components to create a custom armature. The components of the armature may be held together by fasteners such as pins inserted into the connected component. Alternatively, an adhesive or the modeling clay itself may be used to attach the armature components. Once the armature is completely assembled, the modeling clay can be applied to the exterior surfaces to create the sculpture.

The eyes may be the most expressive portion of the sculpture and should be one of the first things attached to the armature. With reference to FIG. 5 the eyes 501 can be various colors, shapes and types. Normally, the eyes will have human coloration 503 and patterns with a circular pupil 505 and have a transparent layer of material over the pupil for a realistic appearance. In other embodiments, the eyes can have slits or star shapes rather than circular pupils. Alternatively, the eyes can have no pupil at all, being all white or all black for creative or strange effects. The eyes may be proportionally sized for the head and spherical in shape or they can be disproportionately small or large for the head. A protrusion 507 may extend from the back of the eye which allows the eye to be more easily inserted into the clay during modeling. Although the eyes are normally placed into the eye sockets it is possible to place the eyes anywhere on exposed clay.

Various appendages and accessories can also be attached to the armature such as horns, antlers, ears, antennae, eyebrows, nose, fangs, etc. These appendages can be used to change the appearance of the armature and in some applications the type of animal can be changed. For example with reference to FIG. 6, a unicorn armature can be formed from a horse head armature 601 by attaching a horn appendage 603 to the forehead of a horse head armature 601. The horn appendage 603 may have a pin 605 which engages a hole in the armature 601. The armature can have holes drilled into its surface to engage these appendages or the appendage can be attached with an adhesive. Alternatively, the appendages may be made of a soft plastic so that the pin 605 can simply be pressed into the armature.

The modeling clay can be applied to the armature in various thicknesses to create the desired appearance and is controlled by the artist. Because the armature is shaped like a head, it may be desirable to apply a thin layer of clay. With reference to FIG. 7, a roller 219 and planar surface 213 may be used to assist the sculptor with forming the thin layer of clay 707. A piece of clay 707 may be placed on the planar surface 703 and rolled onto a flat sheet with the roller 701. In order to control the thickness of the clay 707, uniform thickness rails 709 having a specific thickness may be placed on the sides of the planar surface 703. By rolling the roller 701 over the rails 709, a uniform thickness layer of clay is formed. Rails 709 of different thickness may be used, or stacked rails 711 may be used, so that the desired thickness of the clay can be obtained. Alternatively, the roller itself may have wider diameter ends than the center diameter so that when the clay is rolled over a flat surface, a uniform thickness of clay can be formed. The roller may have multiple end pieces having various diameters so that by swapping the end pieces the thickness of clay can be changed.

After the desired appendages are attached to the armature and the lower jaw is moved to the desired position, a layer of clay is applied by pressing the clay against the armature. The clay should cover most of the exposed areas of the armature, however, it may be desirable to leave certain areas of the armature or appendages uncovered. For example, if horns have been attached to the armature, it may be desirable not to cover its surfaces. Similarly, if the jaw is open, it may be desirable to have at least some of the teeth exposed.

After a layer of clay is attached to the armature, it may be desirable to add additional clay details. With reference to FIG. 2, these clay details may be formed by pressing clay into molds 213 which have the desired detail shapes to form additional sculpture details. These details are quickly formed by pressing the clay into the mold and then removing the clay from the mold. After the detail has been formed it can be attached to the surface of the sculpture. These details may include: eyebrows, ears, noses, jewelry, scars, warts, wounds or other details which allow the sculptor to produce an intricate finished product.

Details that are not formed with molded pieces can be formed with the sculpture tools. The sculpture tools are illustrated in FIG. 8. In general these tools are elongated pieces that have specially shaped ends which are used to work the clay into the desired shape. A first tool 801 may have a pointed flat end 803 and a 45 degree surface 805 at the opposite end. A second tool 807 may have a very small rounded tip 809 on one end and a flat corrugated surface 811 at the opposite end. A third tool 813 may have a curved rounded end 815 and a point 817 at the opposite end. Although three tools with six ends have been illustrated, it is well known that various other types and shapes of tools may be used with the inventive sculpting kit.

By applying clay to the armature and using the tools, facial features such as nose, ears, mouth and eyebrows can be formed using the clay tools. Although the armature may have small protrusions at the nose and ears, the sculptor can add additional clay to these areas to produce larger facial features. Because these tools are suitable for intricate work, they can produce highly detailed surfaces. The final shapes of the facial features control the expression of the sculpture.

Yet another means for customizing the finished sculpture is to add a special texture to the exposed surfaces. The surfaces of the sculpture can be altered by the sculptor's hands or with tools. However, with reference to FIG. 2, a simpler method for creating these effects is to press a textured surface 215 against the exposed clay. By pressing a textured flexible material pad against the exposed clay the texture of the pad is transferred to the exposed surfaces clay. The textured surface pad can add wrinkles, scars, gills, bumps, scales, feathers, fur, or any other type of surface contour. By adding texture, the exposed clay may simulate various types of surfaces such as hair and feathers by shaping the clay and then adding texture to simulate the features that are being replicated.

Various other accessories can be inserted into the soft clay such as hair, jewelry and mechanical equipment. The hair can be any fibrous material which may be individually inserted into the clay. The hair may typically be applied to the top of the head or the lower facial region. Jewelry may be in the form of earrings or other facial piercing. In more gruesome sculptures weapons such as knives or other weaponry may be inserted into the head. In science fiction type sculptures, biomechanical devices may also be inserted into regions of the head. For example, hoses or wires may be inserted into the neck or head to represent a data transfer, life support or other biomechanical systems. The accessories are made of materials that will not melt or be damaged when the sculpture is heated to harden the modeling clay.

Once the exposed clay has been shaped and the accessories have been inserted, the clay is baked to harden the clay. This process is well known in the sculpture art. The sculpture can be left in an unpainted condition but can also be painted to create a more life-like form. With reference to FIG. 2, paint in a variety of paint colors 207 can be applied to the sculpture using a paint brush 221 or any other implement. A thin tipped paint brush should be used to color the more detailed sections. Alternatively, a sponge may be used to create a textured appearance over a larger area. Airbrushing is also a possibility for the more adventurous sculptor. Faux finishes can work as well such as bronze or verdigris and may be applied with commercially available spray paints.

In some applications it may be desirable to reuse the armatures. If the sculpture is a temporary study or the results did not meet expectations, the clay may be removed from the armature. Certain types of modeling clay always remain soft. By using these soft materials, the armature can be ‘stripped’ of clay and re-sculpted into something completely different.

Once the sculpture is painted, it can be mounted on either a base, a body or an extended post. With reference to FIG. 2, the bottom of the head armature 201 may have a fitting 231 that allows it to be securely placed onto a shoulder armature having a mating fitting. The fitting 231 may be a rod that engages a similarly sized hole. Alternatively, the fitting 231 may be a hole that engages a rod or any other type of mechanical connector. The rod may have a hexagonal or octagonal cross section. The fitting 231 is configured to be removably attached to the base 223. A universal ball joint may also be used so the head can be positioned or moved relative to the base 223. A connector is used to attach the fitting to a base, bust or any other structure. Although rods and holes have been described it is contemplated that any other type of mechanical connector may be used as in place of the fitting 231 at the bottom of the armature 201.

With reference to FIG. 9, multiple connectors 901 may be used together to create an elongated neck. These connectors 901 can then be attached to the armature 903. This configuration may be appropriate where the armature is used to create an animal head. The position of the neck is useful in producing a desired expression in the animal.

The best way to display the finished sculpture may be by mounding the sculptured head on a base which provides a stable platform for the sculpture. There are various types of bases that can be used and the most appropriate base will depend upon the sculpture itself. With reference to FIG. 9, the sculpture is an animal head with an elongated neck. Because much of the weight of the sculpture is in the head, a larger base 921 is required to keep the sculpture balanced. Various other base designs are possible and details described with reference to the sculpture can be added to the base as well. The base may also include a frame assembly that can receive a title or name card to identify the sculpture or the sculptor. Alternatively, the base may be embossed or markings may be applied directly to the base or an engraved plaque may be mounted on the base.

With reference to FIG. 3A, the base 321 resembles the neck and shoulders of a person. This type of base may be appropriate for a bust type display. In this embodiment the bust base may be dressed in clothing. As an example, these ‘clothes’ can be an army uniform such as of a general, a space suit, a sports uniform, a clown or any other type of clothing or suits. There is a vast array of clothing possibilities.

Although skulls have been used to create heads, the inventive armature is a distinct structure. The primary difference is that the armature resembles a living head that displays character and guides the sculptor rather than a dead and fairly characterless skull. The inventive armature has nose protrusions rather than orifices. The sculptor uses these protrusions to form the head sculpture. The inventive armature also does not have areas that are normally hollow portions of a skull such as the temples and cheeks. These solid areas of the armatures are designed to represent the exposed surfaces of a normal head.

Although the human head may resemble a skull, there are various differences. A skull represents the bone structure of the head. In contrast, the head armature represents the exterior surfaces of a human head. The back sides of the jaw on the inventive armature have been built out and are not voids to allow the smooth transition of clay from the jaw to the sides of the head. Another distinction is that the teeth may be considerably larger than true scaled human and animal teeth which further adds and differentiates the inventive head armatures from skulls. Another distinction is that the eye sockets of the armature are much larger than those of a skull. The larger eye sockets allow some clay and the eyeballs to be placed in the sockets. The larger sockets also allow a wide variety of eyes to be used with the armature and allow the eyes to be positioned in a wider variety of orientations in the sockets.

The inventive head armature sculpting kit provides a three-dimensional structure upon which modeling clay can be applied to form a character's head design. The shape of the armature structure allows a realistic head to be formed using a minimum of clay. Although the structure provides a basic shape, the user determines the thickness of clay applied to the structure and creates the final shape. The final shape of the sculpted piece can be substantially different than the shape of the armature structure.

The inventive armature structure is an improvement over wire and wood “armatures” which do not provide a good surface for attaching clay. Further, the claimed invention is a complete kit. All the tools necessary to accomplish the task of sculpting and painting and displaying a sculpted head are provided in the inventive sculpture kit which, at present, does not exist in a combined package. Art students or anyone with sculpting interest do not have to gather all of the required components such as aluminum wire and/or wood and work the materials into a form that can serve as a base on which to build a clay sculpture. The sculpture kit provides a very solid foundation for a beginning sculptor to learn sculpting techniques and increases the chances for success right from the start. It also allows the experienced sculptor to bypass the more tedious aspects of laying the foundation for a head sculpture and move straight into the more interesting visual surface of the sculpture.

In the foregoing, a sculpture kit that includes a head armature has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A sculpting kit comprising:
an armature having:
an rounded upper surface;
an eye socket indentation below the upper surface;
an upper jaw below the eye socket, and
a lower jaw below the upper jaw in a hinged connection with the upper jaw; and
a lower surface that includes a fitting that is configured to attach to a connector.

2. The sculpting kit of claim 1 further comprising:
an artificial eye with a diameter smaller than the inner circumference of the eye socket indentation.

3. The sculpting kit of claim 1 further comprising:
a base; and
a connector that is attached to the fitting in lower surface of the armature and the base.

4. The sculpting kit of claim 1 further comprising;
a neck and shoulder structure; and
a connector that is attached to the fitting in lower surface of the armature and the neck and shoulder structure.

5. The sculpting kit of claim 1 further compromising:
paint; and
a paint brush.
wherein the paint is applied over the modeling clay to provide color to the sculpted head.

6. The sculpting kit of claim 1 further comprising:
modeling clay.

7. The sculpting kit of claim 5 further comprising:
a textured material, wherein the textured material can be pressed against the modeling clay to transfer a specific texture to the modeling clay.

8. The sculpting kit of claim 5 further comprising:
a rolling device flattening the modeling clay.

9. The sculpting kit of claim 7 further comprising:
a planar surface with raised rails.

10. The sculpting kit of claim 1 further comprising:
instructional media which provides instructions on how to make a sculpture using the armature.

11. The sculpting kit of claim 1 further comprising:
an elongated sculpting tool.

12. The sculpting kit of claim 1 further comprising:
modeling clay, and
a mold for forming sculpture details with the modeling clay.

13. A sculpting kit comprising:
an armature having:
an upper surface;
an eye socket indentation adjacent to the upper surface;
an nose protrusion;
an upper jaw below the elongated nose protrusion, and a lower jaw below the upper jaw in a hinged connection with the upper jaw;
a rear surface; and
a lower surface;
wherein the rear surface or the lower surface includes a fitting that is configured to attach to a connector.

14. The sculpture kit of claim 13 further comprising:
an artificial eye with a diameter smaller than the inner circumference of the eye socket indentation.

15. The sculpting kit of claim 13 further comprising:
a base; and
a connector that can be attached to the fitting in rear surface or the lower surface of the armature.

16. The sculpture kit of claim 12 further comprising:
an appendage that is attached to the armature.

17. The sculpture kit of claim 13 further comprising:
a set of teeth including a canine tooth attached to the upper jaw; wherein the canine tooth is substantially larger than most of the other teeth.

18. The sculpting kit of claim 13 further compromising:
paint; and
a paint brush.
wherein the paint is applied over the modeling clay to provide color to the sculpted head.

19. The sculpting kit of claim 13 further comprising:
modeling clay.

20. The sculpting kit of claim 1 further comprising:
an elongated sculpting tool and instructional media which provides instructions on how to make a sculpture using the armature
